(19) United States
(12) Patent Application Publication
(10) Pub. No.: US 2006/0280977 A1
(43) Pub. Date: Dec. 14, 2006

(54) Fuel cell system

(75) Inventors: Yuichi Sakajo, Okazaki-shi (JP); Toshiyuki Kawai, Toyohashi-shi (JP); Hideshi Izuhara, Nishi Kamo-gun (JP); Masami Fujitsuna, Kariya-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/436,039

(22) Filed: May 18, 2006

(30) Foreign Application Priority Data
Jun. 9, 2005 (JP) 2005-169238
Jun. 15, 2005 (JP) 2005-174989

(51) Int. Cl. H01M 8/04

(52) U.S. Cl. 429/23

(57) ABSTRACT

A fuel cell system equipped with a fuel cell that generates electrical power in electrochemical reaction of hydrogen and oxygen. The system has the improved cold starting capability that increases heat energy generated in the fuel cell in order to rise the temperature of the fuel cell rapidly in a cold temperature environment. The system has an inverter having plural switching elements connected in series and a control section for controlling ON/OFF operation of the plural switching elements. The control section controls the amount of current output from the fuel cell by performing the ON/OFF control of the switching elements. On commencing the cold starting process of the fuel cell, the control means changes the current path in a drive motor by performing the ON/OFF control of the switching elements, in which both the inverter and the drive motor are used as a variable resistance to the fuel cell.

### CROSS-REFERENCE TO RELATED APPLICATIONS

This application is related to and claims priority from Japanese Patent Applications No. 2005-169238 filed on Jun. 9, 2005 and No. 2005-174989 filed on Jun. 15, 2005, the contents of which are hereby incorporated by reference.

### BACKGROUND OF THE INVENTION

1. Field of the Invention

The present invention relates to a fuel cell system with a fuel cell (FC stack) that generates electrical energy in electrochemical reaction of combining hydrogen and oxygen, and suitably applicable to movable bodies, equipped with a fuel cell system such as an electrical power source, such as in automotive vehicles, electric vehicles, marine vessels, portable power generators, small-sized generators, and other mobile devices.

2. Description of the Related Art

When a fuel cell commences the electrical power generation in a low temperature environment by the electrochemical reaction of hydrogen and oxygen, the fuel cell often stops or does not generate the electrical power because residual water that has been generated in previous electrochemical reaction in the fuel cell is frozen.

In order to avoid the above problem, a conventional fuel cell system equipped with a fuel cell further comprises a variable resistance mounted on the outside of the fuel cell. For instance, the Japanese national publication of translated version Kohyo number JP 2000-512068 has disclosed such a fuel cell system in which the amount of current flow in a fuel cell increases by decreasing a variable resistance value in order to increase a heat to be generated by electrochemical reaction in the fuel cell, and the temperature of the fuel cell thereby rises by the heat generated by the electrochemical reaction.

However, this conventional technique requires an additional electric component such as a variable resistance and thereby the fuel cell system becomes a complicated configuration because of mounting the additional variable resistance. The manufacturing cost of the fuel cell system is thereby increased. It becomes difficult to mount such a fuel cell system equipped with the fuel cell and the variable resistance on vehicles having a limited space.

The Japanese patent laid open publication number JP 2003-109636 has disclosed a fuel cell system of another configuration and technique in which a fuel cell is short circuited by decreasing the value of a variable resistance in order to increase a heat generated by electrochemical reaction in the fuel cell, and the temperature of the fuel cell is increased by the heat of electrochemical reaction.

However, this conventional technique performs the warm-up for the fuel cell prior to the usual operation by making a short circuit of the fuel cell. The fuel cell system requires that an electrical power is supplied to a supplemental part such as an air supply device for supplying air (oxygen) to the fuel cell for electrochemical reaction in the fuel cell. Available modern vehicles having a fuel cell system are often equipped with a secondary battery for supplying electrical power to the supplemental equipment on warm-up of the fuel cell. However, the fuel cell has decreased the capability of electrical power generation in a low temperature environment (for example, −20° C. or below). As a result, in a low temperature environment the fuel cell cannot generate and supply the electrical power of a desired amount. Considered from such a viewpoint, it is not suitable to perform the warm-up of the fuel cell only by using the secondary battery. In order to avoid this problem, there has been proposed another conventional technique disclosing a vehicle equipped with a fuel cell system and additional capacitance instead of the secondary battery. However, in general, a capacitance has a limited capability of storing electrical power.

### SUMMARY OF THE INVENTION

It is an object of the present invention to provide a new and improved fuel cell system with a simple configuration capable of rapidly rising the temperature of a fuel cell during warm-up in a low temperature environment by increasing the amount of heat generated in the fuel cell by adjusting the amount of current for electrical generation in the fuel cell.

To achieve the above purposes, according to one aspect of the present invention, a fuel cell system is provided that has a fuel cell, an electric component, and a control section. The fuel cell is configured to generate electrical power in electrochemical reaction of combining oxidizing agent gas and fuel gas. The electric component is an electric load of the fuel cell and has a plurality of switching elements connected in series. The electrical power is supplied to the electric component from the fuel cell. The control section is configured to performing ON/OFF operation of a plurality of the switching elements in order to control a magnitude of current output from the fuel cell.

It is thereby possible to control the amount of current output from the fuel cell by changing the external resistance in view of the fuel cell by performing the ON/OFF control of the switching elements in the electric component. It is further possible to increase the amount of the heat energy generated in the fuel cell by performing the ON/OFF control for the switching elements so that the amount of the current output from the fuel cell is increased as large as possible.

Further, according to another aspect of the present invention, a fuel cell system is provided that has a fuel cell, an auxiliary equipment, and a control section. The fuel cell is configured to generate electrical power in electrochemical reaction of combining oxidizing agent gas and fuel gas. The auxiliary equipment is used for generating electrical power in the fuel cell. The control section is configured to perform the generation of electrical power by the fuel cell nearly at an operating point having a low voltage in all operating points of the fuel cell in order to generate the electrical power necessary for operating the auxiliary equipment by controlling at least of one of current and voltage of the fuel cell, and configured to provide the generated electrical power to the auxiliary equipment.

Still further, according to another aspect of the present invention, a fuel cell system is provided that has a fuel cell, an auxiliary equipment, a drive motor, and a control section. The fuel cell is configured to generate electrical power in electrochemical reaction of combining oxidizing agent gas and fuel gas. The auxiliary equipment is used for generating electrical power in the fuel cell. The drive motor drives the vehicle. The control section is configured to perform the generation of electrical power by the fuel cell nearly at an operating point having a low voltage in all operating points of the fuel cell in order to generate the electrical power necessary for operating both the auxiliary equipment and the drive motor by controlling at least one of current and voltage of the fuel cell, and is configured to provide the generated electrical power to the auxiliary equipment and the drive motor.

Because the auxiliary equipment can operate by supplying the electrical power from the fuel cell, it is not necessary for the secondary battery to supply the electric power to the auxiliary equipment and it is possible to keep the warm-up function of the fuel cell, namely the cold starting capability of the fuel cell in a cold temperature environment. In addition, because the fuel cell can operate at the operating point having a lower voltage in all operating points of the fuel cell for obtaining the electrical power necessary for performing the auxiliary equipment, it is possible to increase the heat energy generated in the fuel cell while decreasing the generation efficiency of electrical power of the fuel cell by dropping the voltage of the fuel cell. It is thereby possible to perform the warm-up operation of the fuel cell efficiency.

### BRIEF DESCRIPTION OF THE DRAWINGS

A preferred, non-limiting embodiment of the present invention will be described by way of example with reference to the accompanying drawings, in which:

FIG. 1 is a schematic diagram showing the entire configuration of a fuel cell system according to first to fourth embodiments of the present invention;

FIG. 2 is a circuit diagram showing the detailed configuration of a fuel cell, a drive motor, a secondary battery, a DC-DC converter, and an inverter mounted on a vehicle equipped with the fuel cell system shown in FIG. 1;

FIG. 3 is a characteristic diagram showing the change of the I-V characteristic during the generation of electrical power by the fuel cell in the fuel cell system shown in FIG. 1;

FIG. 4 is a characteristic diagram showing the change of the I-V characteristic on changing the temperature of the fuel cell in the fuel cell system according to the first embodiment of the present invention;

FIG. 5 is a flow chart showing the start-up control for the fuel cell system according to the first embodiment of the present invention;

FIG. 6 is a flow chart showing the stoppage control for a fuel cell system on stopping a vehicle equipped with the fuel cell system according to the second embodiment of the present invention;

FIG. 7 is a schematic diagram showing a cooling system in the fuel cell system according to the fourth embodiment of the present invention;

FIG. 8 is a schematic diagram showing the entire configuration of a fuel cell system according to the fifth embodiment of the present invention;

FIG. 9 is a circuit diagram showing the detailed configuration of a drive motor, a secondary battery, a DC-DC converter, and an inverter mounted on a vehicle equipped with the fuel cell system shown in FIG. 8;

FIG. 10 is a flow chart showing the start-up control in the fuel cell system according to the fifth embodiment shown in FIG. 8;

FIG. 11A shows the relationship between current I and voltage V, namely the I-V characteristic during the generation of electrical power by the fuel cell in the fuel cell system shown in FIG. 8;

FIG. 11B shows the relationship between electrical power generated by the fuel cell and power required for the auxiliary equipment; and

FIG. 12 is a characteristic diagram showing the change of the I-V characteristic on changing the temperature of the fuel cell in the fuel cell system shown in FIG. 8.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

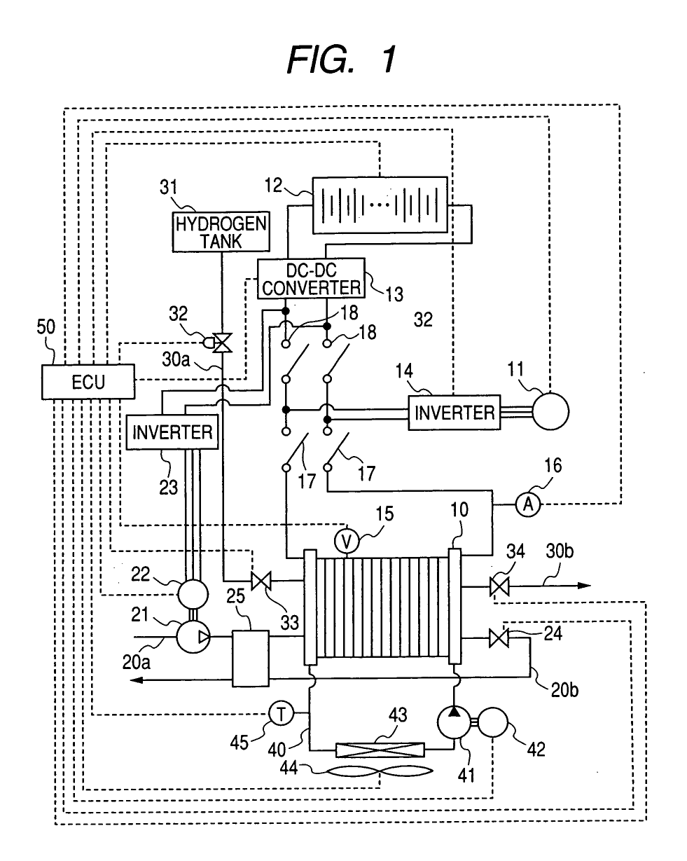

A description will now be given of the fuel cell system according to the first embodiment of the present invention with reference to FIG. 1 to FIG. 5. Following plural embodiments of the present invention will show the fuel cell system of the present invention that is applied to an electric vehicle or a fuel cell vehicle equipped with a fuel cell stack (FC stack) as an electric power source.

FIG. 1 is a schematic diagram showing the entire configuration of the fuel cell system according to first to fourth embodiments of the present invention. As shown in FIG. 1, the fuel cell system of the present invention is equipped with the fuel cell stack (FC stack) 10 that generates electrical power by electrochemical reaction of combining hydrogen and oxygen. The fuel cell 10 supplies the generated electrical power to electrical components mounted on a vehicle, such as a drive motor 11, a secondary battery 12, and auxiliary equipment (electric motor) 22. The auxiliary equipment 22 is an electric motor required for driving the fuel cell 10.

The fuel cell 10 generates the electrical energy by electrochemical reaction of hydrogen and oxygen.

Hydrogen electrode: H₂-->2H⁺+2e⁻, and

Oxygen electrode: 2H⁺+½O₂+2e⁻-->H₂O.

The fuel cell 10 is a polymer electrolyte fuel cell (PEFC) in which a plurality of unit cells are laminated and stacked in multilayered structure. Each unit cell in the fuel cell has a configuration in which a membrane electrolyte assembly is sandwiched by a pair of separators.

The fuel cell system is equipped with an air supply path 20a, an air exhaust path 20b, a hydrogen supply path 30a, and a hydrogen exhaust path 30b. Through the air supply path 20a, air (oxidizing agent gas) is provided to the oxygen electrode end of the fuel cell 10. The air from the fuel cell 10 is exhausted through the air exhaust path 20b. Through the hydrogen supply path 30a, hydrogen (fuel gas) is supplied to the hydrogen electrode end of the fuel cell 10. Residual hydrogen gas which has not been reacted during the electrochemical reaction in the fuel cell 10 is exhausted through the hydrogen exhaust path 30b.

The air supply path 20a is equipped with an air pump 21 as air supply device that compresses air and supplies the compressed air to the fuel cell 10. The air pump 21 is driven by the electric motor 22 as the auxiliary equipment. An open/close valve 24 for opening and closing the air exhaust path 20b is mounted on the air exhaust path 20b. On supplying the air to the fuel cell 10, the open/close valve 24 for the air exhaust path 20b opens and the air pump 21 is driven by the electric motor 22. The electric motor 22 is electrically connected to the secondary battery 12 through an inverter 23.

A humidifier 25 is mounted between the air supply path 20a and the air exhaust path 20b. The humidifier 25 humidifies air supplied from the air pump 21 using water or moisture involved in the air exhausted from the fuel cell 10 so that the polymer electrolyte fuel cell (PEFC) involves the water or moisture in order to perform electrochemical reaction under optimum condition during the generation of electric power.

The hydrogen supply path 30a is equipped with a hydrogen tank 31 filled with hydrogen gas, a hydrogen regulating valve 32 for regulating the pressure of hydrogen gas to be supplied to the fuel cell 10, and an open/close valve 34 for opening and closing the hydrogen supply path 30b.

On supplying hydrogen gas to the fuel cell 10, the open/close valve 33 for the hydrogen supply path 33 opens, and the hydrogen regulating valve 32 regulates the pressure of the hydrogen gas in the hydrogen supply path 30a to a desired pressure. The hydrogen exhaust path 30b is open and closed according to the operation condition by the open/close valve 34 for the hydrogen exhaust path.

Through the hydrogen exhaust path 30b, residual hydrogen gas, water vapor (or water), nitrogen, oxygen and other gases are exhausted. The residual hydrogen gas has not been reacted during the electrochemical reaction in the fuel cell 10. The nitrogen and oxygen pass through the polymer electrolyte fuel cell (PEFC) from the oxygen electrode in the fuel cell 10.

Fuel cell 10 generates heat by performing the electrochemical reaction. In order to maintain the fuel cell 10 at an optimum temperature (for instance, approximate 80° C.) for the electrochemical reaction, the fuel cell 10 is equipped with a cooling system.

The cooling system is equipped with a cooling water (as a coolant) supply path 40 and a water pump 41 for circulating cooling water (heat carrier) through the fuel cell 10. The cooling system is further equipped with an electric motor 42 for driving the water pump 41 and a radiator 43 equipped with an electric fun 44. The heat generated in the fuel cell 10 is conducted by the cooling water and exhausted to the outside of the fuel cell system through the radiator 43. The cooling system having the above configuration can control the amount of cooling water to be supplied to the fuel cell 10 under the cooling water flow control by the water pump 41 and the wind control by the electric fun 44. The electric motor 42 is connected to the secondary battery 12 through an inverter, just like the configuration of the electric motor 22 for the air pump 21. However, the electric connection for the electric motor 42 and the secondary battery 12 is omitted from the drawings for brevity.

A temperature sensor 45 is placed near the outlet of the fuel cell 10 in the cooling water supply path 40. The temperature sensor 45 senses the temperature of the cooling water drained from the outlet of the fuel cell 10. The temperature T_{FC} of the fuel cell 10 is indirectly obtained by detecting the temperature of the cooling water by the temperature sensor 45.

The fuel cell 10 is electrically connected with the secondary battery 12 through a DC-DC converter 13 capable of performing bidirectional supply of electrical power. The DC-DC converter 13 controls the flow of the electrical power between the fuel cell 10 and the secondary battery 12.

An inverter 14 is placed between the fuel cell 10, the DC-DC converter 13, and the drive motor 11. The inverter 14 switches the function of the drive motor 11 that acts a motor and an electric generator.

Both the fuel cell 10 and the secondary battery 12 provide electrical power to the drive motor 11 by the operation of both the DC-DC converter 13 and the inverter 14 when the vehicle equipped with the fuel cell system performs a rapid wheel acceleration and requires a large amount of electric power. Further, under the control of both the fuel cell 10 and the secondary battery 12, the secondary battery 12 accumulates the residual electrical power during the electrical generation by the fuel cell 10 and regenerative electrical power by the drive motor 11.

The fuel cell system is equipped with a voltage sensor 15 for detecting a voltage of the fuel cell 10 and a current sensor 16 for detecting a current of the electrical power generated by the fuel cell 10. On the current path through which the fuel cell 10 is electrically connected to the inverter 14, a primary switch 17 is placed in order to open/close the electrical connection between the fuel cell 10 and the inverter 14. On the current path through which the fuel cell 10 is electrically connected to the DC-DC converter 13, the fuel cell 10, a drive motor system, the secondary battery 12, and a secondary switch 18. The drive motor system has the inverter 14 and the drive motor 11. The secondary switch 18 electrically connects the fuel cell 10 with the secondary battery 12 including an auxiliary equipment system having the auxiliary equipment (electric motor) 22, and electrically disconnet the fuel cell 10 from them. Those switches 17 and 18 are configured to act a relay for opening and closing the electric circuits electrically.

Although each of the primary and secondary switches 17 and 18 is composed of two relays in the embodiment shown in FIG. 1, it is possible to form each switch by a single relay. During usual operation, both the switches 17 and 18 are closed. On the contrary, during the stop of operation of the vehicle, both the switches are open in order to electrically disconnect the fuel cell 10 from other electric components in the fuel cell system for keeping safety.

The fuel cell system is equipped with a control section (ECU) 50 performing various control operations. The control section 50 comprises an available microcomputer having a central processing unit (CPU), a read only memory (ROM), a random access memory (RAM), and an input/output I/O interface. The control section 50 performs various arithmetic operations according to programs stored in the ROM, for example.

The control section 50 inputs various signals such as request signals transferred from various electric loads, a voltage signal transferred from the voltage sensor 15, a current signal transferred from the current sensor 16, and a temperature signal transferred from the temperature sensor 45. The control section 50 is configured to generate and output control signals to the secondary battery 12, the DC-DC converter 13, the inverters 14 and 23, the electric motor 22, the open/close valve 23 for the air exhaust path, the hydrogen regulating valve 32, the open/close valve 33 for the hydrogen supply path, the open/close valve 34 for the hydrogen exhaust path, the electric motor 42, the electric fun 44, and so on.

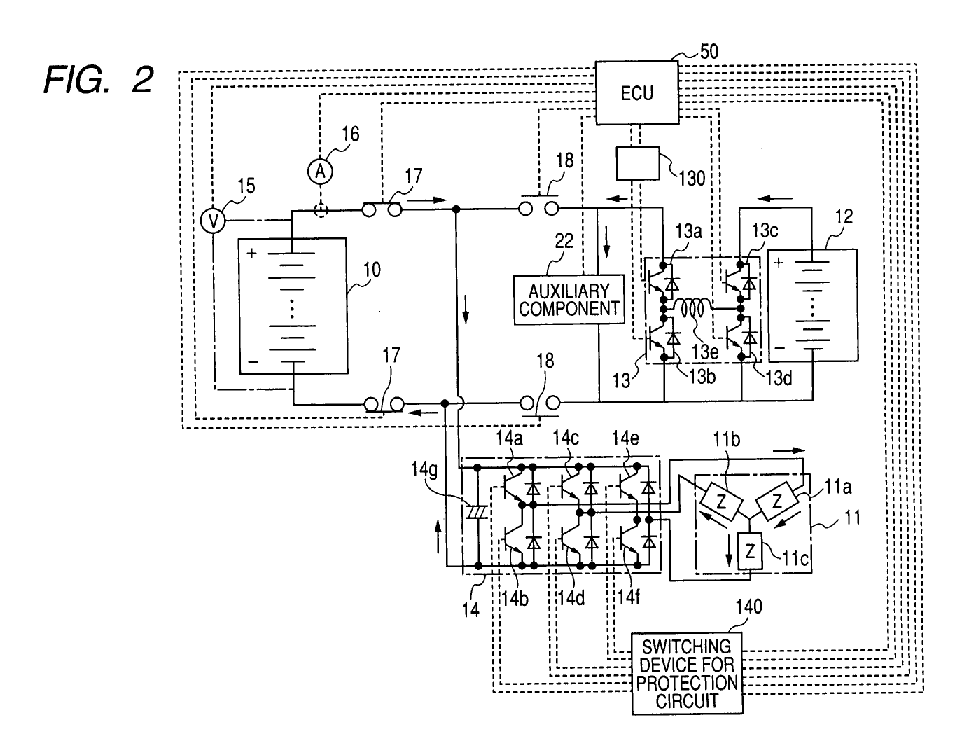

FIG. 2 is a circuit diagram showing a detailed configuration of the fuel cell 10, the drive motor 11, the secondary battery 12, the DC-DC converter 13, and the inverter 14 mounted on the vehicle equipped with the fuel cell system shown in FIG. 1. In the embodiment shown in FIG. 2, although the auxiliary equipment 22 is mounted between the fuel cell 10 and the DC-DC converter 13, it is possible to place the auxiliary equipment 22 between the DC-DC converter 13 and the secondary battery 12.

A three phase AC voltage is generated through the inverter 14. The inverter 14 provides the three phase AC voltage to the drive motor 11. When the drive motor 11 receives the three phase AC voltage, the rotating magnetic field is generated and a rotor in the drive motor 11 rotates. The rotational power generated is transmitted to the wheel of the vehicle and the vehicle thereby runs. Through the embodiments of the present invention, the drive motor 11 is a three phase AC motor. The drive motor 11 has three motor coils 11a to 11c, each of which becomes impedance of each phase. The impedance of each phase is composed of a resistance component and an inductance component.

The inverter 14 has switching elements 14a to 14f and a capacitance 14g. Each of the switching elements 14a to 14f is made of an Insulated Gate Bipolar Transistor (IGBT). A diode is placed for each of the switching elements 14a to 14f for preventing destruction of the switching element. The control section 50 controls ON/OFF operation of each of the switching elements 14a to 14f In the inverter 14, the first switching element 14a and the second switching element 14b are connected in series, the third switching element 14c and the fourth switching element 14d are connected in series, and the fifth switching element 14e and the sixth switching element 14f are connected in series. Each pair of the switching elements 14a and 14b, 14c and 14d, and 14e and 14f will be referred to as “a series connection switching element”.

The inverter 14 has the three series connection switching elements 14a and 14b, 14c and 14d, and 14e and 14f that are connected in parallel to the fuel cell 10. The drive motor 11 has output lines or terminals that are connected to the intermediate nodes of each pair switching elements 14a and 14b, 14c and 14d, and 14e and 14f, respectively.

The fuel cell system further has a protection circuit switching device 140 for controlling whether or not all of the series connection switching elements 14a and 14b, 14c and 14d, and 14e and 14f are ON simultaneously.

It is possible to make the protection circuit switching device 140 by an electric circuit or a mechanical switching mechanism. This protection circuit switching device 140 corresponds to a switching means defined in claims of the present invention.

During the usual operation of the fuel cell 10, it is prevented that all of the series connection switching elements 14a and 14b, 14c and 14d, and 14e and 14f are ON simultaneously in order to avoid that the fuel cell 10 is short-circuited. On the contrary, during the warm-up operation of the fuel cell 10, it is so controlled that all of the series connection switching elements 14a and 14b, 14c and 14d, and 14e and 14f turn ON simultaneously. By turning ON simultaneously all of the series connection switching elements 14a and 14b, 14c and 14d, and 14e and 14f, the fuel cell 10 is short circuited in order to increase the amount of heat generated therein.

In the embodiment of the present invention, the current path is switched by the ON/OFF control of the switching elements 14a to 14f and the inverter 14 and the drive motor 11 become variable resistances, and the amount of current output from the fuel cell 10 is adjusted by changing the variable resistances.

As a concrete example, following three states (1) to (3) are switched in order to use the inverter 14 and the drive motor 11 as variable resistance.
(1) The fuel cell 10 is short circuited by turning ON all of the series connection switching elements 14a and 14b, 14c and 14d, and 14e and 14f. In this case, no current flows through the drive motor 11;
(2) First, current flows through one of the coils 11a to 11c in the drive motor 11 and then the current flows in the remaining two coils of the coils 11a to 11c connected in parallel; and
(3) Current flows in two coils, connected in series, in the coils 11a to 11c of the drive motor 11.

Further, in order to adjust the amount of current output from the fuel cell 10, chopper control is performed using the switching elements in the switching elements 14a to 14f through which the current supplied from the fuel cell 10 flows.

The DC-DC converter 13 is a back boost chopper circuit capable of adjusting the voltage of the fuel cell 10 and the voltage of the secondary battery 12. The DC-DC converter 13 performs voltage transformer by which the electrical power generated by the fuel cell 10 is charged to the secondary battery 10 and the electrical power charged in the secondary battery 12 is provided to the drive motor 11 and the auxiliary equipment 22. Thus, it is possible to transmit the electrical power between the fuel cell 10 and the secondary battery 12 regardless of the magnitude of the voltage.

The DC-DC converter 13 has the switching elements 13a to 13d and the coil 13f. Each of the switching elements 13a to 13d is made of an Insulated Gate Bipolar Transistor (IGBT). A diode is placed for each of the switching elements 13a to 13d for preventing destruction of the switching element. The switching elements 13a to 13d are composed of two pairs of the switching elements 13a and 13b, and 13c and 13d.

When both the switching elements 13a and 13d turn ON simultaneously, the current flows through the coil 13e toward the right direction on FIG. 2. On turning OFF both the switching elements 13a and 13d simultaneously, the current flows from the coil 13e to the secondary battery 12 through the switching elements 13b and 13d.

The electrical power generated by the fuel cell 10 is charged to the secondary battery 12 by performing ON/OFF control of the switching elements 13a and 13d. Thus, the control section 50 controls the ON/OFF operation of each of the switching elements 13a and 13d.

The fuel cell system further has a protection circuit switching device 130 for controlling whether or not both the switching elements 13a and 13b, are ON simultaneously. It is possible to make the protection circuit switching device 130 by an electric circuit or a mechanical switching mechanism.

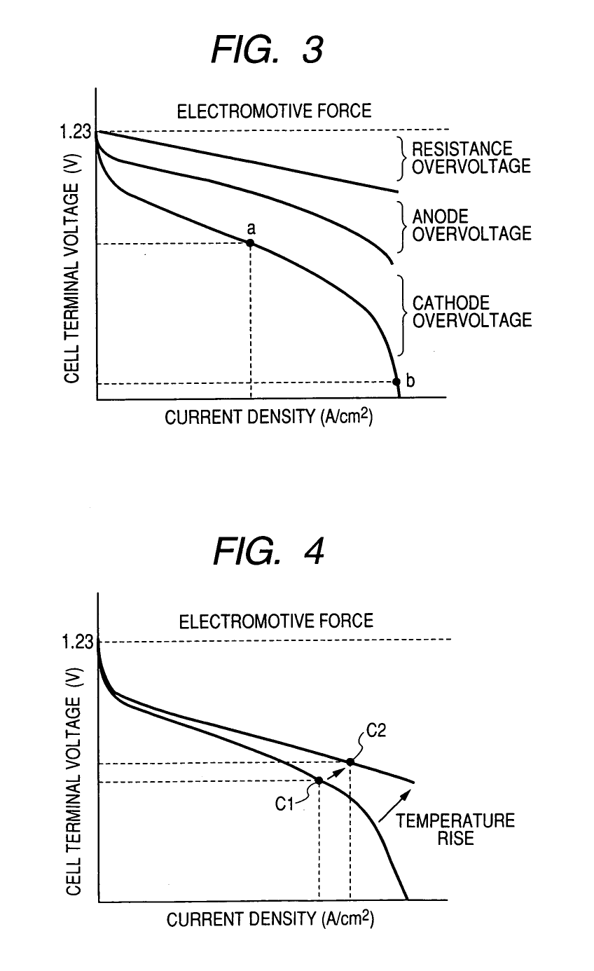

FIG. 3 is a characteristic diagram showing the change of current and voltage (I-V) characteristic during the generation of electrical power by the fuel cell 10 in the fuel cell system shown in FIG. 1. As shown in FIG. 3, because each unit cell forming the fuel cell 10 has the resistance overvoltage, the anode overvoltage, and the cathode overvoltage, the cell terminal voltage drops according increasing the density of current flowing in the unit cell. The dropped voltage of each unit cell is converted to thermal energy in the unit cell. Thus, the thermal energy increases the temperature of the fuel cell.

During the usual operation, the fuel cell 10 operates at the neighborhood of the point “a” shown in FIG. 3. The cell terminal voltage is not less than 0.6 Volts at the point “a” that provides the good efficiency of the generation of electrical power. On performing the operation at a low voltage, the fuel cell 10 generates a low electrical power and operates at the neighborhood of the point “b” shown in FIG. 3. At the point “b”, the cell terminal voltage is approximately zero volts, and the resistance overvoltage, the anode overvoltage, and the cathode overvoltage are increased, and the thermal energy in the unit cell 10 is thereby increased.

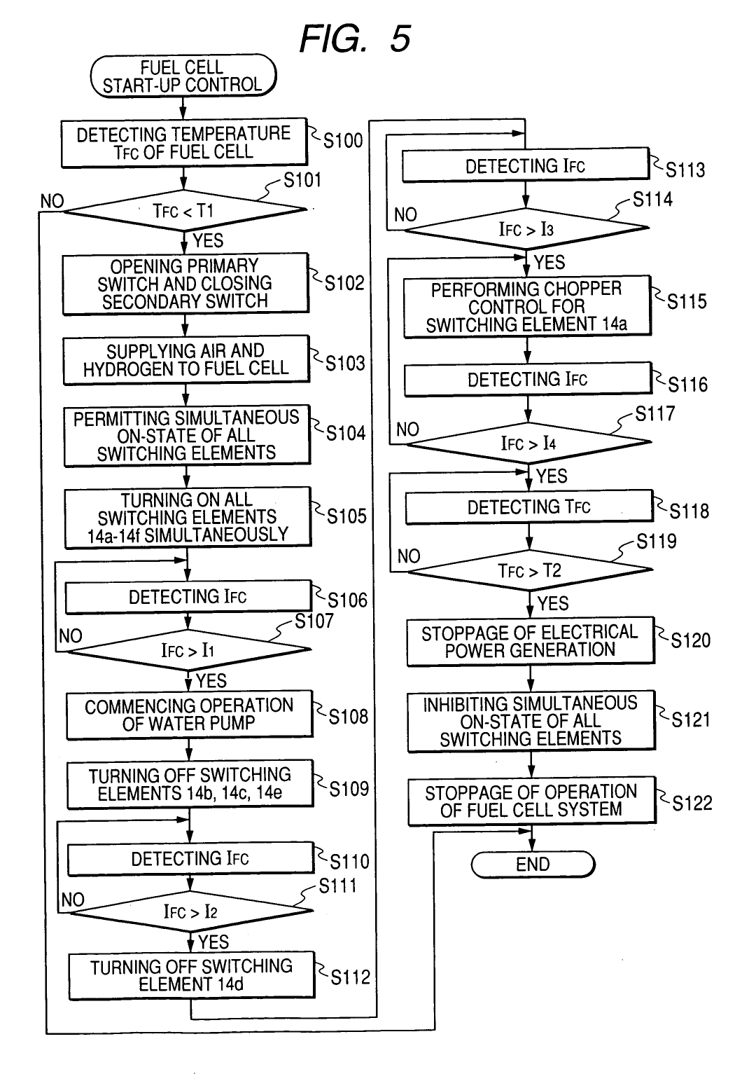

FIG. 4 is a characteristic diagram showing the change of I-V characteristic on changing the temperature of the fuel cell 10 in the fuel cell system shown in FIG. 1.

When the temperature of the fuel cell 10 rises, the resistance of the electrolyte film in the fuel cell 10 decreases and the catalyst in the cathode electrode and the anode electrode is activated, and each overvoltage decreases. Thereby, according to the increase of the temperature of the fuel cell, the cell terminal voltage and the current density increase as shown in FIG. 4. Because the area for the generation of electrical energy is constant, the magnitude of output current of the fuel cell 10 is proportional to the current density.

When the fuel cell 10 operates at the point C1 under the low voltage operation, the operation point of the fuel cell 10 is shifted from the point c1 to the point c2 according to increase of the temperature of the fuel cell. Further, the cell terminal voltage of the fuel cell 10 increases and the current value (or the current density) also increases. Thus, according to the increase of temperature of the fuel cell in the low voltage operation, the magnitude of the current of the fuel cell 10 increases.

When the amount of current output from the fuel cell 10 increases dramatically, the thermal energy generated in the fuel cell 10 also increases. It is possible for this condition to destroy the fuel cell 10. In order to avoid this problem, the amount of current of the fuel cell 10 is controlled by adjusting the magnitude of the external resistance comprised of the inverter 14 and the drive motor 11 in view of the fuel cell 10.

Next, a description will now be given of the start-up operation of the fuel cell system according to the first embodiment with reference to FIG. 5.

FIG. 5 is a flow chart showing a start-up control for the fuel cell system according to the first embodiment of the present invention. The CPU in the control section 50 performs the start-up control shown in FIG. 5 according to the control programs stored in the ROM (not shown). A driver of the vehicle equipped with the fuel cell system enters a key switch (not shown) and thereby the start-up control process is initiated.

In the start-up control process, the temperature sensor 45 detects the temperature T_{FC} of the fuel cell 10 (step S100) and diagnoses whether or not the temperature T_{FC} is lower than a first specified temperature T1 that has been determined in advance (step S101). The first specified temperature T1 is a parameter for judging the necessity of the warm-up operation for the fuel cell 10. The first specified temperature T1 is set to an optional value for various conditions. When the judgment result indicates that the temperature T_{FC} of the fuel cell 10 is not more than the first specified temperature T1, it is not necessary to initiate the warm-up process. Therefore the start-up control process is completed.

On the contrary, when the judgment result indicates that the temperature T_{FC} of the fuel cell 10 is lower than the first specified temperature T1, it can be judged that the fuel cell 10 requires the warm-up operation. The secondary switch 18 is opened, and the primary switch is closed (step S102).

When the secondary switch 18 is opened, the drive motor system having the fuel cell 10, the inverter 14 and the drive motor 11 is electrically disconnected from the auxiliary equipment system having the secondary battery 12 and the auxiliary equipment 22. In this state, the secondary battery 12 provides the electrical power to the auxiliary equipment 22 though the DC-DC converter 13. Although the secondary switch 18 is opened in the above description, it is acceptable to close the secondary switch 18.

Next, the supply of hydrogen and oxygen to the fuel cell 10 is initiated (step S103). The fuel cell 10 thereby commences the generation of electrical power.

Following, the protection circuit switching device 140 permits to turn ON all of the series connection switching elements 14a and 14b, 14c and 14d, and 14e and 14f are ON simultaneously (step S104). All of the switching elements 14a and 14b, 14c and 14d, and 14e and 14f are turned thereby ON simultaneously (step S105). The fuel cell 10 is electrically connected to the inverter 14. That is, the fuel cell 10 and the inverter 14 form an electric circuit. The switching elements 14a and 14b make a short circuit to the fuel cell 10, the switching elements 14c and 14d make a short circuit to the fuel cell 10, and the switching elements 14e and 14f make a short circuit to the fuel cell 10. Those short circuits are electrically connected to the fuel cell 10.

Accordingly, because the current from the fuel cell 10 is divided into those short circuits, it is possible to decrease the amount of the current flowing through each short circuit and to increase the amount of current output from the fuel cell 10 when compared with the case in which the current from the fuel cell 10 flows into one short circuit. That is, the amount of current output from the fuel cell 10 can be increased

As described above, by making the short circuit with the fuel cell and the switching elements, the cell terminal voltage approaches to zero volts, and the efficiency of the electrical power of the fuel cell 10 is decreased, and the amount of heat generation in the fuel cell 10 rises. This causes the temperature generated in the fuel cell 10 to rise. When the temperature of the fuel cell 10 rises, the catalyst in the cathode electrode and the anode electrode is activated, and the magnitude of the output current of the fuel cell 10 is increased.

Next, the current sensor 16 detects the current value I_{FC} output from the fuel cell 10 (step S106) and the control section 50 judges whether or not the current value I_{FC} is over a specified temperature (step S107).

The steps S106 and S107 are repeatedly performed until the current sensor 16 detects that the current value I_{FC} output from the fuel cell 10 exceeds the first specified current value I₁. The first specified current value I₁ is a parameter for judging the generation state of electrical power by the fuel cell 10. The first specified current value I₁ is set to an optional value.

When the judgment result in step S107 indicates that the current value I_{FC} exceeds the first specified current value I₁, it can be considered that the temperature of the fuel cell 10 rises and reaches the optimum temperature for generating electrical power even if a cooling water is circulated therein. Accordingly, the water pump 41 is started for circulating the cooling water to the fuel cell 10 (step S108). Thereby, overheating of the fuel cell 10 and uneven temperature distribution can be prevented.

Next, the second switch element 14b, the third switch element 14c, and the fifth switch element 14e turn OFF (step S109). The current of the fuel cell 10 flows through the first coil 11a in the drive motor 11. The current flowing in the first coil 11a is divided into the second coil 11b and the third coil 11c. Further, the current of the second coil 11b flows into the fourth switching element 14d, and the current of the third coil 11c flows into the sixth switching element 14f.

As described above, each of the coils 11a to 11c are the impedance of each phase and composed of a resistance component and an inductance component. Because of the resistance component of each of the coils 11a to 11c, if the electromotive force of the fuel cell 10 is constant, it is possible to reduce the magnitude of the current of the fuel cell 10 by making the current path through the coils 11a to 11c in the drive motor 11.

It is possible to suppress any rush current generated by the short-circuit fuel cell 10 because of the inductance component in each of the coils 11a to 11c. If the fuel cell has a relatively high temperature at its start-up, it is possible to perform step S109 firstly without performing step S105.

Next, the current sensor 16 detects the current value I_{FC} output from the fuel cell 10 (step S110), and it is judged whether or not the current value I_{FC} exceeds the second specified current value I₂ (step S111). The step S110 and step S111 are repeated until it is judged that the current value I_{FC} exceeds the second specified current value I₂. The second specified current value I₂ is a parameter for judging the generation state of electrical power by the fuel cell 10 and is also set to an optional value for various conditions. It is so set that the second specified current value I₂ is higher than the first specified current value I₁.

When the judgment result in step S111 indicates that the current value I_{FC} exceeds the second specified current value I₂, the fourth switching element 14d turns OFF (step S112). No current thereby flow from the first coil 11a to the coil 11b, but the current flows from the first coil 11a to the fuel cell 10 through the third coil 11c.

It is possible to reduce the magnitude of the current of the fuel cell 10 through the first coil 11a and the third coil 11c because of the increase of the magnitude of the combined resistance when compared with the configuration in which the current flows from the first coil 11a to both the second coil 11b and the third coil 11c.

Next, the current sensor 16 detects the current value I_{FC} output from the fuel cell 10 (step S114), and it is judged whether or not the current value I_{FC} exceeds the third specified current value I₃ (step S114).

The step S113 and step S114 are repeated until it is judged that the current value I_{FC} exceeds the third specified current value I₃. The third specified current value I₃ is a parameter for judging the generation state of electrical power by the fuel cell 10 and is also set to an optional value for various conditions. It is so set that the third specified current value I₃ is higher than the second specified current value I₂.

When the judgment result in step S114 indicates that the current value I_{FC} exceeds the third specified current value I₃, the chopper operation for the first switching element 14a is performed (step S115).

The current sensor 16 detects the current value I_{FC} output from the fuel cell 10 (step S116), and it is judged whether or not the current value I_{FC} exceeds the fourth specified current value I₄ (step S117). Like the first to third specified current values I₁, I₂, and I₃, the fourth specified current value I₄ is a parameter for judging the generation state of electrical power by the fuel cell 10 and is also set to an optional value for various conditions. It is so set that the fourth specified current value I₄ is set as the maximum value or upper limit value of the output current from the fuel cell 10, and of course, it is so set that the fourth specified current value I₄ is higher than the third specified current value I₃.

When the judgment result in step S117 indicates that the current value I_{FC} does not exceed the fourth specified current value I₄, the operation flow returns to step S115. The chopper control for the first switching element 14a is continuously performed until the current value I_{FC} exceeds the fourth specified current value I₄ in order to prevent that the output current of the fuel cell 10 exceeds the fourth specified current value I₄.

When the judgment result in step S117 indicates that the current value I_{FC} exceeds the fourth specified current value I₄, the current sensor 45 detects the current value T_{FC} of the fuel cell 10 (step S118), and it is judged whether or not the temperature value T_{FC} exceeds the second specified temperature value T2 (step S119). The second specified temperature value T2 is a parameter for judging the completion of the warm-up operation for the fuel cell 10 and is also set to an optional value for various conditions. It is so set that the second specified temperature value T2 is higher than the first specified temperature value T1.

When the judgment result indicates that the temperature value T_{FC} of the fuel cell 10 does not exceed the second specified temperature value T2, the operation flow returns to step S118, and steps S118 and S119 are repeatedly performed until it is judged that the temperature value T_{FC} of the fuel cell 10 exceeds the second specified temperature value T2.

When the judgment result in step S119 indicates that the temperature value T_{FC} exceeds the second specified temperature value T2, both the first switching element 14a and the sixth switching element 14f turn OFF, the supply of both hydrogen and Oxygen to the fuel cell is halted in order to stop the generation of electrical power in the fuel cell 10 (step S120). Further, the protection circuit switching device 140 prevents that the series connection switching elements 14a and 14b, 14c and 14d, and 14e and 14f in the inverter 14 turn ON simultaneously (S121). The water pump 41, the auxiliary equipment 22 and the like is stopped, and the entire fuel cell system is thereby stopped in operation.

As described above in detail, at the warm-up of the fuel cell 10, it is possible to reduce the generation efficiency of electrical power in the fuel cell 10 by rising the amount of current output from the fuel cell 10 by reducing the cell terminal voltage of the fuel cell 10. As a result, it is possible to increase the amount of heat energy generated in the fuel cell, and possible to rise the temperature of the fuel cell 10 rapidly in the warm-up process of the fuel cell 10.

It is further possible to use both the inverter 14 and the drive motor 11 as variable resistance by performing ON/OFF operation of the switching elements 14a to 14f in the inverter 14, and thereby possible to control the current value of the fuel cell 10. That is, even if the output current of the fuel cell 10 is small in a low temperature environment, it is possible to increase the amount of current output from the fuel cell 10 as large as possible and to increase the amount of heat energy generated in the fuel cell 10 by adjusting the external resistance in view of the fuel cell 10. According to the increase of the temperature of the fuel cell 10 and of the output current of the fuel cell 10, it is so controlled that the external resistance in view of the fuel cell 10 is set to a larger value in order to prevent an excess output current from the fuel cell 10.

On start-up of the fuel cell 10 in a low temperature environment, it is possible to use the drive motor 11 and the inverter 14 as variable resistances because those drive motor 11 and inverter 14 are usually out in use at the start-up process.

As described above in detail according to the fuel cell system of the first embodiment of the present invention, it is possible to enhance the cold starting capability of the fuel cell 10 by using the existing configuration components in the fuel cell system without newly additional components. It is thereby possible to manufacture the fuel cell system having a high performance of warm-up at the low temperature with a simple configuration and possible to mount the fuel cell system on a vehicle without difficulty.

### Second Embodiment

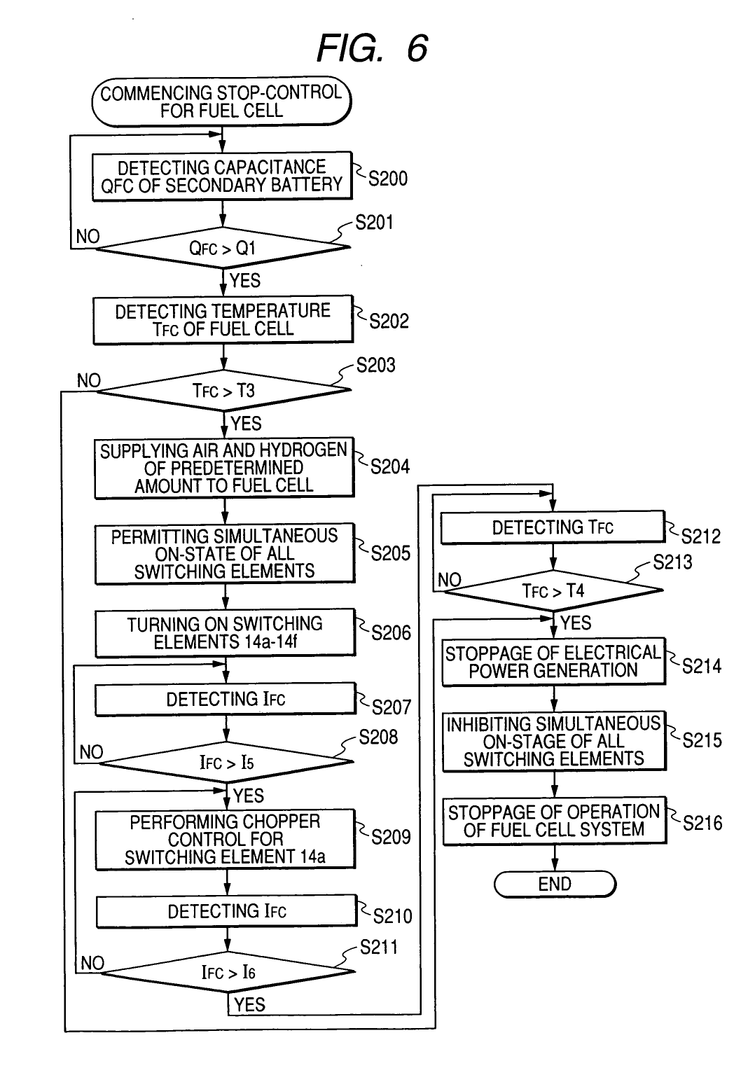

Next, a description will now be given of the fuel cell system according to the second embodiment with reference to FIG. 6.

If residual water remains in the fuel cell 10 at the completion of the electrical power generation, there is a possibility that the residual water in the fuel cell 10 will be frozen in a low temperature environment. On re-starting the fuel cell 10 mounted on a vehicle in a low temperature environment, there is a great possibility to be difficult to perform electrochemical reaction in the fuel cell 10 and also difficult to start-up the operation of the fuel cell 10 even if reaction gases (Hydrogen and Air) are supplied to the fuel cell 10 because frozen water plug reaction-gas supply paths and prevents the supply of the reaction gases to polymer electrolyte films in the fuel cell 10.

The fuel cell system according to the second embodiment has an improved cold starting capability in which the warm-up operation is performed at the stoppage of the fuel cell 10 in order to eliminate the residual water from the fuel cell 10 by rising the temperature of the fuel cell 10.

FIG. 6 is a flow chart showing a stoppage control for the fuel cell system on stopping a vehicle equipped with the fuel cell system according to the second embodiment of the present invention.

In the fuel cell system of the second embodiment, the CPU in the control section 50 performs the control programs stored in the ROM. A driver of a vehicle equipped with the fuel cell system stops the operation of the fuel cell by turning OFF a key-switch of the vehicle. On generating electrical power of the fuel cell, the generation of electrical power in the fuel cell 10 and the operation of the water pump 41 are continued even if the driver turns OFF the key.

First, the residual capacitance Q_{FC} of the secondary battery 12 is detected (step S200), it is judged whether or not the detected residual capacitance Q_{FC} exceeds a specified capacitance Q1 (step S201). The specified capacitance Q1 is a parameter for judging the necessity of charging to the secondary battery 12 and set to an optional value for various conditions. When the judgment result in step S201 indicates that the detected residual capacitance Q_{FC} does not exceed the specified capacitance Q1, the operation flow returns to step S200, and the secondary battery 12 is charged by continuously performing the fuel cell 10 until the residual capacitance Q_{FC} detected exceeds the specified capacitance Q1.

On the contrary, when the judgment result in step S201 indicates that the detected residual capacitance Q_{FC} exceeds the specified capacitance Q1, the operation flow returns to step S200, the temperature sensor 45 detects the temperature of the fuel cell T_{FC} (step S202), and it is judged whether or not the temperature T_{FC} of the fuel cell 10 is lower than the third specified temperature T3 that has been determined in advance (step S203). The third specified temperature T3 is a parameter for judging the necessity of the warm-up operation for the fuel cell 10. The third specified temperature T3 is set to an optional value for various conditions.

When the judgment result in step S203 indicates that the detected temperature T_{FC} of the fuel cell 10 is not less than the third specified temperature T3, the operation forwards to step S214 because of not necessary to perform the warm-up operation.

On the contrary, when the judgment result in step S203 indicates that the detected temperature T_{FC} of the fuel cell 10 is lower than the third specified temperature T3, because of the necessary of performing the warm-up operation, it is so controlled that the air (Oxygen) and hydrogen of a specified amount are supplied to the fuel cell (step S204).

Next, the protection circuit switching device 140 permits to turn ON all of the series connection switching elements 14a and 14b, 14c and 14d, and 14e and 14f simultaneously (step S205). All of the switching elements 14a and 14b, 14c and 14d, and 14e and 14f turn ON simultaneously (step S206). The fuel cell 10 is electrically connected to the inverter 14. That is, the fuel cell 10 and the inverter 14 form an electric circuit. The switching elements 14a and 14b make a short circuit to the fuel cell 10, the switching elements 14c and 14d make a short circuit to the fuel cell 10, and the switching elements 14e and 14f make a short circuit to the fuel cell 10. Those short circuits are electrically connected to the fuel cell 10.

Accordingly, because the current from the fuel cell 10 is divided into those short circuits, it is possible to decrease the amount of the current flowing through each short circuit and to increase the magnitude of the output current from the fuel cell 10 when compared with the case in which the current from the fuel cell 10 flows into one short circuit. That is, the magnitude of the output current from the fuel cell 10 can be increased

As described above, by making the short circuit with the fuel cell 10 and the switching elements, the cell terminal voltage approaches to zero volts, and the generation efficiency of electrical power of the fuel cell 10 is decreased, and the amount of heat energy generated in the fuel cell 10 rises. This causes that the temperature of the fuel cell 10 rises. When the temperature of the fuel cell 10 rises, the catalyst in the cathode electrode and the anode electrode is activated, and the amount of current output from the fuel cell 10 is increased.

Next, the current sensor 16 detects the current value I_{FC} output from the fuel cell 10 (step S207), and it is judged whether or not the current value I_{FC} exceeds a fifth specified current value I₅ (step S208). The step S207 and step S208 are repeated until it is judged that the current value I_{FC} exceeds the fifth specified current value I₅. The fifth specified current value I₅ is a parameter for judging the generation state of electrical power by the fuel cell 10 and is also set to an optional value for various conditions.

When the judgment result in step S208 indicates that the current value I_{FC} exceeds the fifth specified current value I₅, the chopper control for the first switching element 14a is performed (step S209).

The current sensor 16 detects the current value I_{FC} output from the fuel cell 10 (step S210), and it is judged whether or not the current value I_{FC} exceeds a sixth specified current value I₆ (step S210). The sixth specified current value I₆ is a parameter for judging the generation state of electrical power by the fuel cell 10 and is also set to an optional value for various conditions. It is so set that the sixth specified current value I₆ is set as the upper limit value of the output current from the fuel cell 10, and of course, it is so set that the sixth specified current value I₆ is higher than the fifth specified current value I₅.

When the judgment result in step S211 indicates that the current value I_{FC} is not more than the sixth specified current value I₆, the operation flow returns to step S209. The chopper control for the first switching element 14a is continuously performed until the current value I_{FC} exceeds the sixth specified current value I₆ in order to prevent that the output current of the fuel cell 10 exceeds the sixth specified current value I₆.

When the judgment result in step S211 indicates that the current value I_{FC} exceeds the sixth specified current value I₆, the current sensor 45 detects the current value T_{FC} of the fuel cell 10 (step S212), and it is judged whether or not the temperature value T_{FC} exceeds the fourth specified temperature value T4 (step S213). The fourth specified temperature value T4 is a parameter for judging the completion of the warm-up operation for the fuel cell 10 and is also set to an optional value for various conditions. It is so set that the fourth specified temperature value T4 is higher than the third specified temperature value T3.

When the judgment result in step S213 indicates that the temperature value T_{FC} of the fuel cell 10 is not more than the fourth specified temperature value T4, the operation flow returns to step S212, and steps S212 and S213 are repeatedly performed until it is judged that the temperature value T_{FC} of the fuel cell 10 exceeds the fourth specified temperature value T4.

When the judgment result in step S213 indicates that the temperature value T_{FC} exceeds the fourth specified temperature value T4, both the first switching element 14a and the sixth switching element 14f turn OFF, the supply of both hydrogen and air to the fuel cell is halted in order to stop the generation of electrical power in the fuel cell 10 (step S214). Further, the protection circuit switching device 140 prevents that the series connection switching elements 14a and 14b, 14c and 14d, and 14e and 14f in the inverter 14 are ON simultaneously (step S215). The water pump 41, the auxiliary equipment 22 and the like is stopped, and the entire of the fuel cell system is thereby stopped in operation (step S216).

As described above in detail, according to the fuel cell system of the second embodiment, it is possible to reduce the moisture content or the water percentage contained in the inside of the fuel cell 10 by setting the fuel cell 10 at a high temperature when the fuel cell 10 is stopped in a low temperature environment. After this, the fuel cell 10 is stopped completely. Thus, it is possible to prevent that the water in the fuel cell 10 is frozen in a low temperature environment. This can increase the cold starting capability of the fuel cell 10 in the fuel cell system.

Therefore because the fuel cell system of the second embodiment does not require any additional external heating means such as an electric heating device, the fuel cell system of the second embodiment has a high mounting capability on a vehicle. Further, because the heat energy generated in the fuel cell 10 is used for reducing the amount of water contained in the inside of the fuel cell 10, it is possible to rise the fuel cell 10 rapidly by a large amount of heat energy generated.

### Third Embodiment

Next, a description will now be given of the fuel cell system according to the third embodiment.

In the first and second embodiments described above, the fuel cell system is so controlled that both the switching elements 13a and 13d are turned ON simultaneously when the electrical power generated in the fuel cell 10 is supplied to the secondary battery 12.

The fuel cell system of the third embodiment has the same function of the fuel cell systems of the first and second embodiments, which changes the amount of current output from the fuel cell 10 by adjusting the switching frequency while performing the ON/OFF control for the switching elements 13a and 13d.

Because it is possible to flow the large amount of current from the fuel cell 10 during usual operation, the control section 50 controls the switching elements 13a and 13d by using a high frequency (for example, not less than 10 kHz). Using a low switching frequency makes a long-period ON state of both the switching elements 13a and 13d. This makes a short circuit of the fuel cell 10, and as a result a large amount of current from the fuel cell 10 flows. This is a problem for the fuel cell system, in particular, for the fuel cell 10.

However, because the output capability of the fuel cell 10 drops and it becomes difficult to obtain a large amount of current from the fuel cell 10 in a low temperature environment, it is preferred to set the switching frequency of the DC-DC converter 13 as low as possible. Setting the switching frequency of the DC-DC converter 13 as low as possible is equivalent to set the external resistance of the fuel cell 10 to a low value. It is therefore possible to have a large amount of current output from the fuel cell 10 and to increase the heat energy generated in the fuel cell 10. In order to prevent the flow of excess current from the fuel cell 10, the switching frequency can be set high according to the increase of the temperature of the fuel cell 10.

It is acceptable to control simultaneously the operation of the DC-DC converter 13 and the ON/OFF operation of the inverter 14 disclosed in the first and second embodiments.

### Fourth Embodiment

Next, a description will now be given of the fuel cell system according to the fourth embodiment.

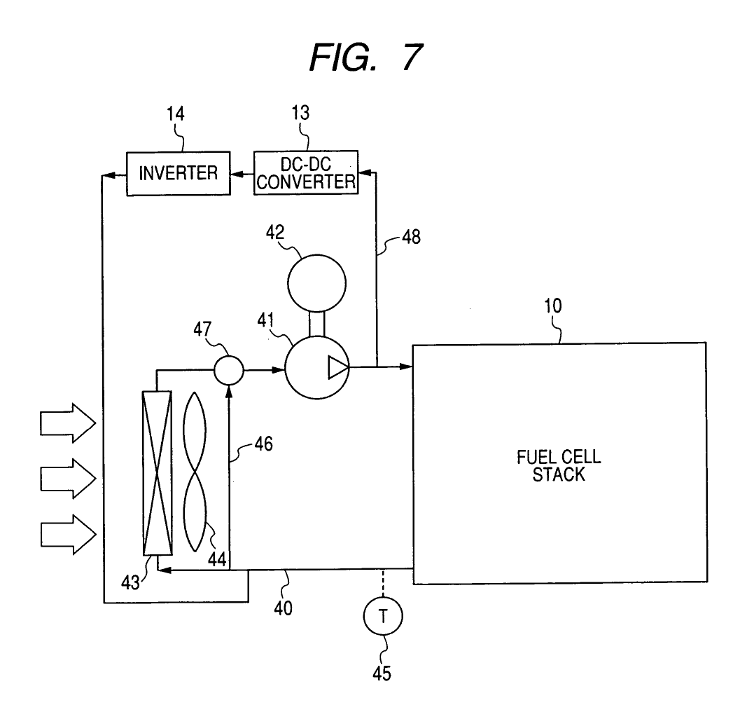

FIG. 7 is a schematic diagram showing a cooling system for the fuel cell system according to the fourth embodiment of the present invention.

The cooling system of the fourth embodiment is equipped with a bypass 46 and a path switching valve 47. The bypass 46 bypasses the cooling water from a radiator 43. The path switching valve 47 switches the flow of the cooling water to one of the radiator 43 and the bypass 46.

The fuel cell system of the fourth embodiment has a common cooling system for both the fuel cell 10 and the DC-DC converter 13. That is, the cooling water path 48 through which the cooling water is circulated to the DC-DC converter 13 is joined to the cooling water path 40 through which the cooling water is circulated to the fuel cell 10. This means that a part of the cooling water flowing through the cooling water path 40 flows into both the DC-DC converter 13 and the inverter 14.

This configuration can rise the temperature of the cooling water flowing through the cooling water path 40 because the heat energy generated in the DC-DC converter 13 and the inverter 14 is provided to the fuel cell 10 through the cooling water. Accordingly, the heat energy generated in the DC-DC converter 13 and the inverter 14 can rise the temperature of the fuel cell 10 through the cooling water to be circulated.

### Other Examples

In step S105 of the fuel cell system of the first embodiment, all of the series connection switching elements 14a and 14b, 14c and 14d, and 14e and 14f turn ON simultaneously. However, the present invention is not limited by the configuration, it is possible to make a short circuit by using a pair or two pairs of the series connection switching elements that turn ON simultaneously. Further, it is acceptable to make a short circuit of the fuel cell 10 by using the switching elements 13a and 13b of the DC-D converter 13, or to make a short circuit of the fuel cell 10 by using the combination of the switching elements of the inverter 14 and the DC-DC converter 13.

In the fuel cell system of the first embodiment, the external resistance to the fuel cell 10 is adjusted by switching the flow of current in the drive motor 11 while performing the ON/OFF control for the switching elements in the inverter 14. However, the present invention is not limited by the configuration. It is possible to change the magnitude of the external resistance to the fuel cell 10 by using the switching elements in the inverter 14. As a concrete example, the number of the series connection switching elements 14a, 14b, 14c, 14d, 14e, and 14f that turn ON simultaneously is changed.

The magnitude of the external resistance to the fuel cell 10 is increased gradually according to the order of three pairs of, two pairs of, a pair of the series connection switching elements in the inverter 14 to be used for making a short circuit.

Although the ON/OFF control for the switching elements in the inverter 14 is performed based on the detection value of the current sensor 16, the present invention is not limited by the configuration, it is possible to perform the ON/OFF control for the switching elements in the inverter 14 based on the detection value of the voltage sensor 12.

In the first to fourth embodiments described above, the temperature of the fuel cell 10 is estimated based on the temperature of the cooling water drained from the fuel cell 10 detected by the temperature sensor 45, it is also acceptable to detect the temperature of the fuel cell 10 by using another detection means.

### Summary of the First Embodiment to Fourth Embodiment According to the Present Invention

The fuel cell system of the present invention has a fuel cell, an electric component, and a control means. The fuel cell is configured to generate electrical power in electrochemical reaction of combining oxygen gas and fuel gas. The electric component is an electric load of the fuel cell and has a plurality of switching elements connected in series to which the electrical power is supplied from the fuel cell. The control means is configured to performing ON/OFF operation of a plurality of the switching elements in order to control the amount of current output from the fuel cell.

It is thereby possible to control the amount of current output from the fuel cell by changing the external resistance in view of the fuel cell by performing the ON/OFF control of the switching elements of the electric component. It is further possible to increase the amount of the heat energy generated in the fuel cell by performing the ON/OFF control for the switching elements so that the amount of current output from the fuel cell is increased as large as possible.

Another feature of the present invention is to have an inverter configured to convert a direct current output from the fuel cell to an alternating current or a DC-DC converter configured to transform a voltage output from the fuel cell as the electric component.

Further, another feature of the present invention is to have an electric motor when the fuel cell system has the inverter as the electric component. It is thereby possible to change the external resistance to the fuel cell by changing the direction of current flow in the electric motor based on the ON/OFF control for the switching elements in the inverter.

Another feature of the present invention is to control the output current from the fuel cell by adjusting the switching frequency for the switching elements in the DC-DC converter when the electrical power generated in the fuel cell is charged to the secondary battery.

By decreasing the switching frequency, it is possible to obtain a large amount of current from the fuel cell because this is equivalent to the decrease of the external resistance. It is thereby possible to increase the heat energy generated in the fuel cell as large as possible. On the contrary, by increasing the switching frequency, it is possible to decrease the amount of current output from the fuel cell because this is equivalent to the increase of the external resistance. This can prevent the flow of excess current.

Another feature of the present invention is to incorporate the switching means configured to permit or inhibit that all of a plurality of the switching elements connected in series turn ON simultaneously. It can be prevented during usual operation that the fuel cell is short-circuited by entering ON simultaneously all of the switching elements.

Further, during warm-up operation, it is possible to increase the amount of the heat energy generated in the fuel cell by making a short circuit of the fuel cell turning ON simultaneously all of the switching elements.

Another feature of the present invention is to perform the ON/OFF control of the switching elements based on the magnitude of output current from the fuel cell detected by the current sensor. It is thereby possible to monitor the generation state of electrical power in the fuel cell in order to perform the generation of electrical power of the fuel cell at an optimum condition.

Another feature of the present invention is to perform the ON/OFF control of the switching elements based on the magnitude of output voltage of the fuel cell detected by the voltage sensor. It is thereby possible to monitor the generation state of electrical power in the fuel cell in order to perform the generation of electrical power of the fuel cell at an optimum condition.

Another feature of the present invention is to perform the ON/OFF control of the switching elements based on the amount of both output current and output voltage of the fuel cell detected by the current sensor and the voltage sensor. It is thereby possible to monitor the generation state of electrical power in the fuel cell in order to perform the generation of electrical power of the fuel cell at an optimum condition.

Another feature of the present invention is to have a configuration in which a common heating medium such as a coolant is circulated through the fuel cell and the electric equipments. It is thereby possible to rise the temperature of the fuel cell by using the heat energy generated by the electric equipments.

### Fifth Embodiment

Next, a description will now be given of the fuel cell system according to the fifth embodiment.

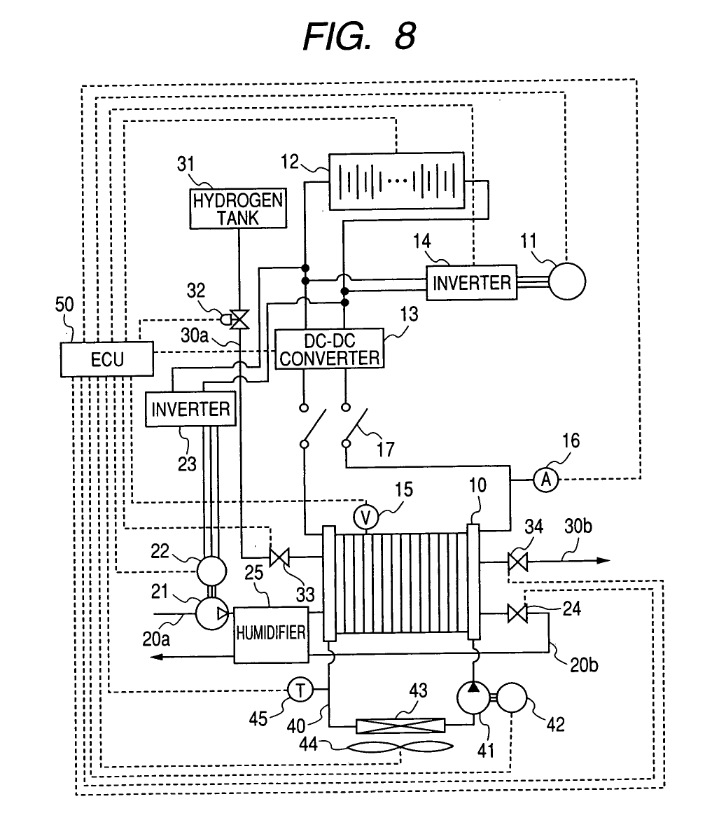

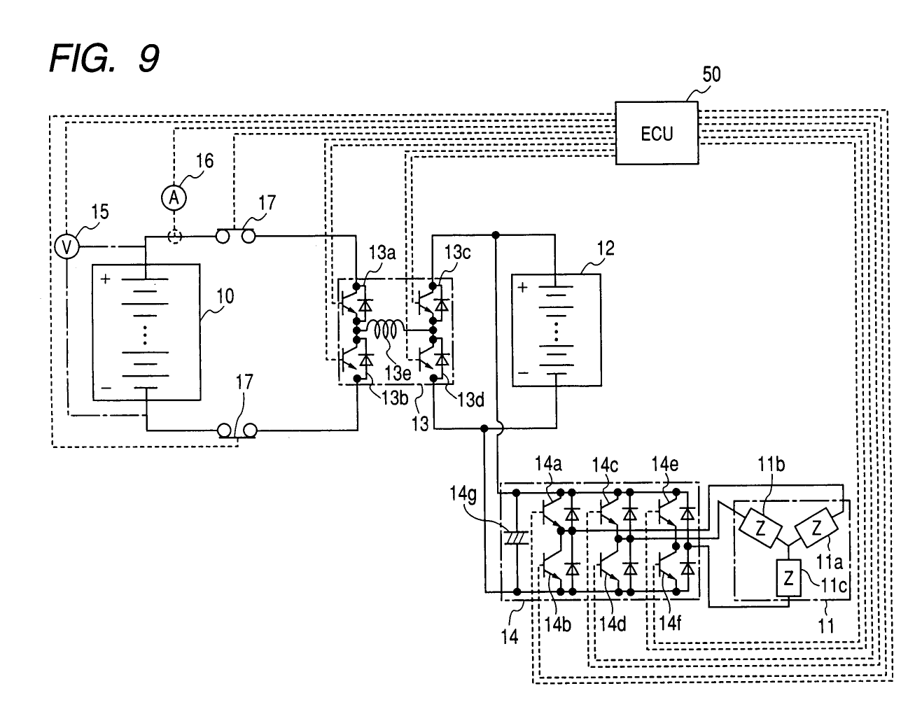

FIG. 8 is a schematic diagram showing the entire configuration of a fuel cell system according to the fifth embodiment of the present invention. FIG. 9 is a circuit diagram showing a detailed configuration of a drive motor, a secondary battery, a DC-DC converter, and an inverter mounted on a vehicle equipped with the fuel cell system shown in FIG. 8.

The configuration of the fuel cell system of the fifth embodiment shown in FIG. 8 is similar to that of the fuel cell system of the first embodiment shown in FIG. 1. The explanation for the same components between the fuel cell system of the fifth embodiment shown in FIG. 8 and the fuel cell system of the first embodiment shown in FIG. 1 is omitted here for brevity.

The electric motor 22 in the fuel cell system of the fifth embodiment shown in FIG. 8 corresponds to the auxiliary equipment and oxygen gas supply means defined in claims of the present invention.

Further, the fuel cell 10 is electrically connected with the secondary battery 12 through a DC-DC converter 13 capable of performing bidirectional supply of electrical power. The DC-DC converter 13 controls the flow of the electrical power between the fuel cell 10 and the secondary battery 12. The DC-DC converter 13 and the control section 50 correspond to the control means defined in claims of the present invention.

The inverter 14 is placed between the fuel cell 10, the secondary battery 12, and the drive motor 11. The inverter 14 switches the function of the drive motor 11 that acts a motor and an electric generator.

The fuel cell system is equipped with a voltage sensor 15 for detecting a voltage of the fuel cell 10 and a current sensor 16 for detecting a current of the electrical power generated by the fuel cell 10. On the current path through which both the electrodes of the fuel cell 10 are electrically connected to the DC-DC converter 13, the switch 17 is placed in order to open/close the electrical connection between the fuel cell 10 and the electric components such as the inverter 14. During the operation of the fuel cell 10, the switch 17 is closed to make the electrical connection, and during the halt of the fuel cell 10, the switch 17 is opened (insulated) for safety.

Like the first embodiment, the fuel cell system of the fifth embodiment is equipped with the control section (ECU) 50 performing various control operations. The control section 50 comprises an available microcomputer having a central processing unit (CPU), a read only memory (ROM), a random access memory (RAM), and input/output I/O interface. The control section 50 performs various arithmetic operations according to programs stored in the ROM, for example. The ROM in the control section 50 stores the I-V characteristic table regarding the change of efficiency of electrical power generated in the fuel cell 10 in advance.

Other components of the fuel cell system of the fifth embodiment shown in FIG. 8 are the same of those of the fuel cell system according to the first embodiment shown in FIG. 1.

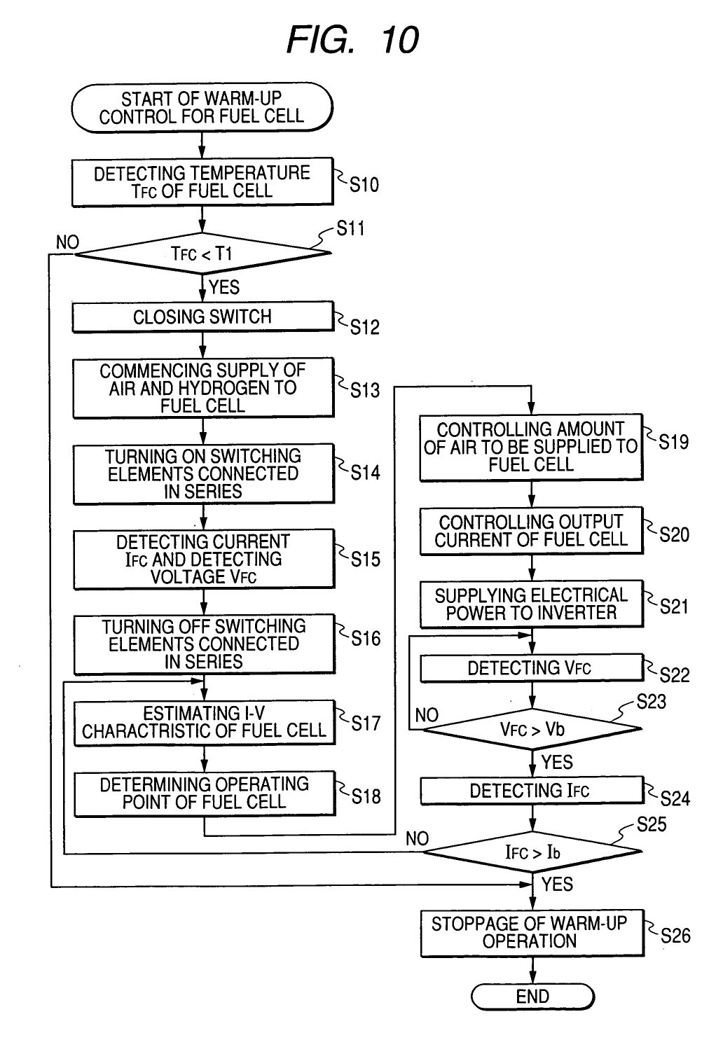

Next, a description will now be given of the start-up control of the fuel cell system of the fifth embodiment with reference to FIG. 10.

FIG. 10 is a flow chart showing a start-up control in the fuel cell system according to the fifth embodiment shown in FIG. 8.

The CPU in the control section 50 performs the start-up control shown in FIG. 10 according to control programs stored in the ROM (not shown). The driver of the vehicle equipped with the fuel cell system enters a key switch (not shown) and thereby the start-up control process is initiated.

The secondary battery 12 or a low voltage battery (for example, 14 volts, not shown) provides the electrical power necessary for the control section 50 and the electric motor 22 for the air pump 21 before the commencement of the generation of electrical power in the fuel cell 10.

First, the temperature sensor 45 detects the temperature T_{FC} of the fuel cell 10 (step S10) and judges whether or not the temperature T_{FC} is lower than the first specified temperature T1 that has been determined in advance (step S11). The first specified temperature T1 is a parameter for judging the necessity of the warm-up operation for the fuel cell 10. The first specified temperature T1 is set to an optional value for various conditions. When the judgment result in step S11 indicates that the temperature T_{FC} of the fuel cell 10 is not less than the first specified temperature T1, because it is not necessary to commence the warm-up process, the start-up control process is completed.

On the contrary, when the judgment result indicates that the temperature T_{FC} of the fuel cell 10 is lower than the first specified temperature T1, because it is judged that the fuel cell 10 requires the warm-up operation, the switch 17 is closed (step S12). When the switch 17 is closed, the fuel cell 10, the DC-DC converter 13 and the inverter 14 are electrically connected.

Next, the supply of hydrogen and oxygen to the fuel cell 10 is initiated (step S13). The air pump 21 supplies a specified amount of air. Because the fuel cell does not generate electrical power at this time, the secondary battery 12 supplies the electrical power to the drive motor 22 through the inverter 23. The open/close valve 24 for opening and closing the air exhaust path is regulated in order to supply the air of a specified amount to the fuel cell 10. The open/close valve 33 for the hydrogen supply path opens, and the hydrogen regulating valve 32 regulates the pressure of the hydrogen gas in the hydrogen supply path to a desired pressure. Because the fuel cell 10 consumes hydrogen gas for generating the electric power, the pressure of the hydrogen gas in the supply path is decreased. In order to keep a specified pressure of the hydrogen supply, the additional hydrogen gas is supplied.

Next, a short circuit to the fuel cell 10 is made by turning ON both the series connection switching elements 13a and 13b in the DC-DC converter (step S14). In this condition, the current sensor 16 detects the current value I_{FC} output from the fuel cell 10 and the voltage sensor 15 detects the voltage V_{FC} of the fuel cell (step S15), and the switching elements 13a and 13b in the DC-DC converter 13 turn OFF (step S16).

Next, the I-V characteristic of the fuel cell 10 is estimated based on the current value I_{FC} and the voltage value V_{FC} detected in step S15 by using the IV-characteristic table stored in the ROM (not shown) in advance (step S17).

This estimation is performed by mating the operating point of the current value I_{FC} and the voltage value V_{FC} with the operation point in the IV-characteristic table (step S18).

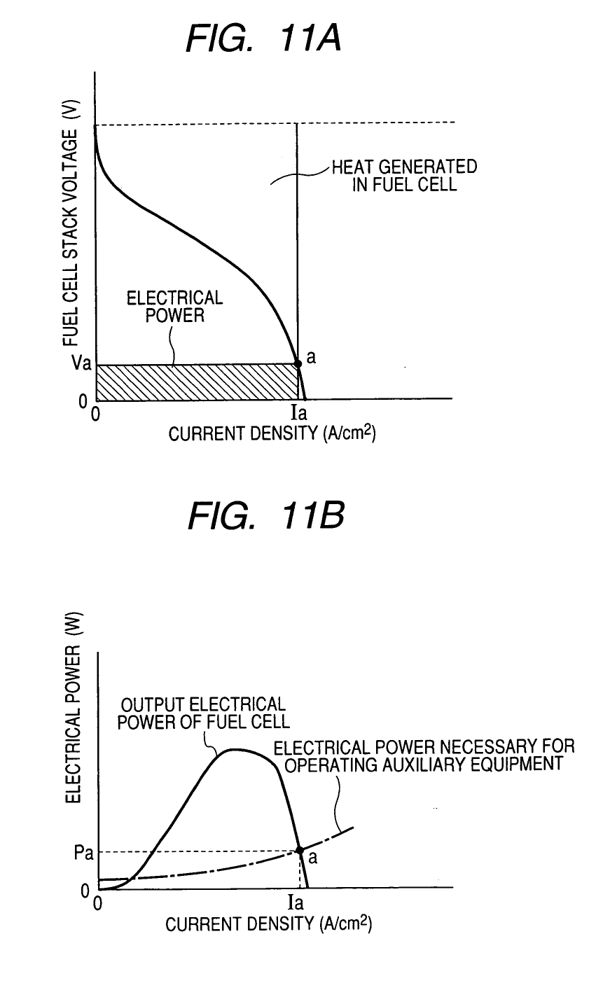

The determination manner of the operating point of the fuel cell 10 will be explained with reference to FIG. 11A and FIG. 11B.

FIG. 11A is a relationship between the current I and the voltage V, namely I-V characteristic during the generation of electrical power by the fuel cell in the fuel cell system shown in FIG. 8. FIG. 11B shows a relationship between the electrical power generated by the fuel cell and the power required for the auxiliary equipment.

The power required for the auxiliary equipment is the required minimum power of the electric motor 22 for the air pump 21 in order to generate the electric power with a desired amount of current in the fuel cell 10.

In FIG. 11A, the solid line indicates I-V characteristic of the fuel cell 10, and the area surrounded by the slanting lines denotes the chemical energy of hydrogen. The area surrounded by the slanting lines shown in FIG. 11A is converted to electrical energy and remaining area is converted to heat energy that becomes the heat energy of the fuel cell 10.

As clearly understood from FIG. 11A, when the generation efficiency of electrical power in the fuel cell 10 is reduced, the amount of generated electric power is decreased and the amount of heat energy is increased instead. The generation efficiency is defined by a ratio between the amount of hydrogen consumption and the amount of electrical power generated in the fuel cell 10.

Under a constant current control, the generation efficiency of electric power in the fuel cell 10 is decreased according to the decrease of the voltage. The generation efficiency of electric power in the fuel cell 10 can be adjusted by decreasing the amount of supply of reaction gases (hydrogen gas and oxidizing agent gas) when compared with the amount during usual operation and by decreasing a resistance value between the electrodes of the fuel cell 10 in order to decrease the voltage between the electrodes of the fuel cell 10.

As shown in FIG. 11B, the electrical power generated in the fuel cell 10 rises according to the increase of current (or current density), and then drops after taking its peak at a specified current. The power required for the auxiliary equipment crosses the curve of the electrical power generated in the fuel cell 10 at two points. In the fifth embodiment, the cross point having a lower voltage (current value Ia, voltage value Va) in the two points is used as the operating point. On operating the fuel cell 10 at the operating point “a”, it is possible to use the electrical power generated in the fuel cell 10 as the power required for the auxiliary equipment in order to generate the electrical power by the fuel cell 10.

Next, the amount of air supply to the fuel cell 10 is controlled (step S19). The drive motor 22 is controlled so that the amount of air necessary for operating the fuel cell 10 at the operating point “a” is supplied to the fuel cell 10. The DC-DC converter 13 is controlled so that the fuel cell 10 outputs a constant current (step S20). In the case shown in FIG. 11A and FIG. 11B, it is so controlled that the output current from the fuel cell 10 keeps the current value at the point Ia.

The electrical power is supplied to the drive motor 22 through the inverter 23 (step S21). The amount of air desired is supplied to the fuel cell 10 by the air pump 21.

Next, the voltage sensor 15 detects the voltage value V_{FC} of the fuel cell 10 (step S22), it judges whether or not the detected voltage value V_{FC} exceeds the specified voltage value Vb (step S23). The specified voltage value Vb is a parameter for judging the generation state of electrical power by the fuel cell 10 and is also set to an optional value for various conditions.

As a result, when the judgment result in step S23 indicates that the detected voltage V_{FC} of the fuel cell 10 is not more than the specified voltage Vb, the operation flow returns to step S22, and the step S22 and step S23 are repeated until it is judged that the voltage value V_{FC} exceeds the specified voltage Vb.

The reason why the voltage value of the fuel cell 10 is detected in step S23 will be explained with reference to FIG. 5.

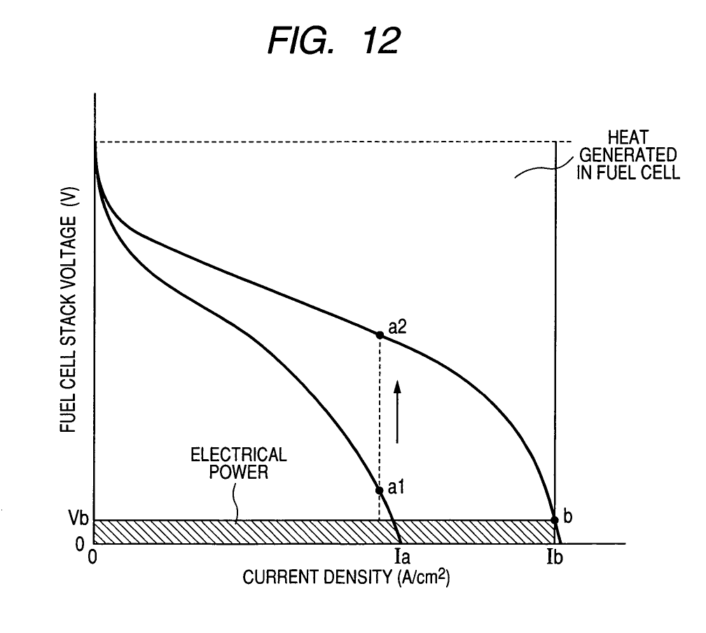

FIG. 12 shows the change of I-V characteristic hen the temperature of the fuel cell 10 rises.

When the temperature of the fuel cell 10 rises, the catalyst in the cathode electrode and the anode electrode of the fuel cell 10 is activated, and the electric conductivity of the electrolyte film of the fuel cell 10 increases. The generation efficiency of electrical power in the fuel cell 10 thereby increases. Because the constant current control is performed in step S20, the voltage of the fuel cell 10 increases, and the operating point of the fuel cell is shifted from the point a1 to the point a2, as shown in FIG. 12.

Because the generation efficiency of electrical power in the fuel cell 10 increases, the fuel cell 10 generates the electrical power more than necessary.

In the fifth embodiment, the operating point of the fuel cell 10 is shifted from the point a2 to the operating point b by increasing the current flow of the fuel cell 10, and the generation efficiency of the fuel cell 10 is decreased by dropping the voltage of the fuel cell 10 in order to increase the heat energy in the fuel cell. The operating point b indicates a lower voltage value and higher current value (Ib, Vb) in the cross points of the electrical power of the fuel cell 10 and the electrical power necessary for the auxiliary equipment.

By operating the fuel cell 10 at the operating point b, it is possible for the fuel cell 10 to generate the electrical power necessary for the auxiliary equipment when the fuel cell 10 generates the electrical power. Because the generation efficiency of electrical power of the fuel cell 10 at the operating point b is higher than that at the operating point a1, the heat energy of the fuel cell 10 increases and the warm-up of the fuel cell 10 can be promoted.

When the judgment result in step S23 indicates that the detected voltage value V_{FC} of the fuel cell 10 exceeds the specified voltage Vb, the current sensor 16 detects the current value I_{FC} output from the fuel cell 10 (step S24) and the control section 50 judges whether or not the current value I_{FC} exceeds the specified current value I_{b} (step S25).

The specified current value I_{b} is set to a value more than the current value Ia at the operating point a1.

As a result, when the judgment result in step S25 indicates that the current value I_{FC} of the fuel cell 10 does not exceed the specified current value I_{b}, the operation flow returns to step S17, steps S17 and S25 are repeatedly performed until the current value I_{FC} of the fuel cell 10 exceeds the specified current value I_{b}. That is, the estimated I-V characteristic of the fuel cell 10 is re-estimated (step S17), the operating point of the fuel cell 10 is set to the point b (step S18), and air supply amount control (step S19) and the current value control (step S20) are performed in order to set the current value of the fuel cell becomes the value I_{b}.

When the judgment result in step S25 indicates that the current value I_{FC} of the fuel cell 10 exceeds the specified current value I_{b}, because it can be judged that the fuel cell 10 is warmed adequately, the warm-up process is therefore completed.

As described above, the I-V characteristic of the fuel cell 10 is obtained and it is so controlled that the fuel cell 10 generates the electrical power nearly at the operating point of the fuel cell 10 required for performing the auxiliary equipment 22 necessary for adequately executing the generation of the electrical power of the fuel cell 10, the generated electric power is supplied to the auxiliary equipment 22. This can perform the auxiliary equipment 22 by the electrical power supplied from the fuel cell 10.

Further, because the fuel cell 10 generates the electrical power nearly at the operating point of a lower voltage level in the operating points capable of generating the electrical power necessary for operating the auxiliary equipment 22, the generation efficiency of electrical power can be decreased by dropping the voltage level of the fuel cell 10, it is thereby possible to increase the amount of heat energy generated in the fuel cell 10 and to perform the warm-up for the fuel cell 10 efficiency.

In addition, because the electrical power necessary for operating the auxiliary equipment 22 is obtained from the fuel cell 10, it is not necessary for the secondary battery 12 to supply the electrical power to the auxiliary equipment 22, and it is thereby possible to warm the fuel cell 10 in a low temperature environment in which the performance of the secondary 12 battery 12 becomes low. Further, because the electrical power generation control for the fuel cell 10 is performed by using the existing components such as the DC-DC converter 13 and the inverter 14 incorporated in the fuel cell system, it is necessary to incorporate no additional components for the warm-up operation such as a variable resistance.

Further, if the increase of current from the fuel cell 10 is detected according to the rise of the temperature of the fuel cell 10, the I-V characteristic of the fuel cell 10 is determined again and newly operating point is determined. This allows to perform the warm-up operation for the fuel cell 10 at the optimum operating point efficiency.

### Another Example

In the fuel cell system of the fifth embodiment shown in FIG. 8 to FIG. 12, the cooling water is not circulated to the fuel cell 10 during the warm-up process in order to prevent the deterioration of the cold starting capability in a low temperature environment. However, it is acceptable to circulate the cooling water to the fuel cell 10 if the cold starting capability can be kept.

Furthermore, in the fuel cell system of the fifth embodiment, off gas involving residual hydrogen gas that is not reacted exhausted from the fuel cell 10 is not re-circulated to the fuel cell 10. However, it is possible to construct the fuel cell system so that the off gas is joined to hydrogen gas to be supplied to the fuel cell 10 by using circulation means such as an ejector and a pump for supplying the hydrogen gas.

Moreover, in the fuel cell system of the fifth embodiment, although the auxiliary equipment 22 is the electric motor 22 for driving the air pump 21, the present invention is not limited by this configuration. For example, the operating point of the fuel cell 10 is determined based on the electrical power necessary for performing the pump for the hydrogen gas supply in addition to the electric motor if the fuel cell system re-circulates the off gas to the fuel cell 10 by the pump for the hydrogen gas supply. Further, if there is a necessity to charge the secondary battery 12, the operating point of the fuel cell 10 is determined based on the electrical power necessary for charging the secondary battery 12 in addition to the electrical power necessary for the electric motor and the pump for the hydrogen gas supply.

Further, in the fuel cell system of the fifth embodiment, although the warm-up process is performed during the stop of a vehicle, it is acceptable to perform the warm-up process during the driving of the vehicle. In this case, the operating point of the fuel cell 10 is determined based on the electrical power necessary for driving the vehicle in addition to the electrical power necessary for the auxiliary equipment. It is thereby possible to perform the warm-up operation for the fuel cell 10 while driving the vehicle.

Still further, in the fuel cell system of the fifth embodiment, although the warming-up condition for the fuel cell 10 is determined based on the current value of the fuel cell 10 detected in step S25, it is possible to check the warm-up condition of the fuel cell 10 based on the temperature of the fuel cell detected by the temperature sensor 45.

Still further, in the fuel cell system of the fifth embodiment, although the constant current control for the fuel cell 10 is performed in step S20, it is possible to perform constant voltage control for the fuel cell 10 so that the voltage of the fuel cell 10 is set to a voltage value Va. In this case, because the magnitude of current from the fuel cell 10 increases according to increasing the generation efficiency of electrical power in the fuel cell 10, it is only judged whether the current value I_{FC} of the fuel cell 10 detected in step S22 and step S23 exceeds the specified current value Ib.

### Summary of the Fifth Embodiment According to the Present Invention

The fuel cell system according to the present invention has a fuel cell, an auxiliary equipment, and a control section. The fuel cell is configured to generate electrical power in electrochemical reaction of combining oxygen gas and fuel gas. The auxiliary equipment is used for the generation of electrical power in the fuel cell. The control means is configured to performing the generation of electrical power by the fuel cell nearly at an operating point having a low voltage in all of operating points of the fuel cell in order to generate the electrical power necessary for operating the auxiliary equipment by controlling at least one of a current and a voltage of the fuel cell, and configured to provide the generated electrical power to the auxiliary equipment.

Because the auxiliary equipment can operate by supplying the electrical power from the fuel cell, it is not necessary for the secondary battery to supply the electric power to the auxiliary equipment and it is possible to keep the warm-up function of the fuel cell, namely the cold starting capability of the fuel cell in a cold temperature environment.

In addition, because the fuel cell can operate at the operating point having a lower voltage in all operating points of the fuel cell for obtaining the electrical power necessary for performing the auxiliary equipment, it is possible to increase the heat energy generated in the fuel cell while decreasing the generation efficiency of electrical power of the fuel cell by dropping the voltage of the fuel cell. It is thereby possible to perform the warm-up operation of the fuel cell efficiency.

Another feature of the present invention, the control means controls so that the fuel cell operates at the operating point having a lower voltage in all operating points at which the electrical power necessary for performing both the auxiliary equipment and the drive motor can be obtained and the electrical power of the fuel cell is supplied to the auxiliary equipment and the drive motor. The optimum operating point for the fuel cell can be determined by considering the drive motor in addition to the auxiliary equipment. Therefore it is possible to perform the warm-up operation for the fuel cell while running a vehicle equipped with the fuel cell system.

Another feature of the present invention is that the auxiliary equipment includes the oxidizing agent supply means for supplying oxidizing agent gas to the fuel cell. It is thereby possible to perform the generation of electrical power in the fuel cell. When the fuel cell system has the configuration to circulate the off gas involving residual hydrogen gas that is not reacted exhausted from the fuel cell to the fuel cell again, the electrical power necessary for the auxiliary equipment includes the electrical power for the hydrogen gas supply pump. Further, if there is a necessity for charging the electrical power to the secondary battery during the warm-up for the fuel cell, the electrical power to be charged to the secondary battery is also included as the electrical power necessary for the auxiliary equipment.

Another feature of the present invention is that the control means obtains the current-voltage (I-V) characteristic showing the relationship between the current and voltage of the fuel cell, and determines the operating point having a low voltage based on the current-voltage characteristic obtained.

Another feature of the present invention is to further have the voltage detection means for detecting the voltage of the fuel cell. The control means controls the magnitude of the fuel cell. When the detected voltage exceeds the voltage level corresponding to the operating point having a lower voltage, the control means obtains a newly current-voltage (I-V) characteristic and determines the operating point having a lower voltage based on the newly obtained I-V characteristic. It is thereby possible to perform the warm-up process efficiency at the obtained optimum operating point when the current of the fuel cell is increased according to the temperature rise of the fuel cell.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A fuel cell system comprising:
a fuel cell configured to generate electrical power in electrochemical reaction of combining oxidizing agent gas and fuel gas;
an electric component as a electric load of the fuel cell, comprising a plurality of switching elements connected in series, to which the electrical power is supplied from the fuel cell;
control means configured to performing ON/OFF operation of a plurality of the switching elements in order to control the amount of current output from the fuel cell.

2. The fuel cell system according to claim 1, wherein the electric component is an inverter configured to convert a direct current output from the fuel cell to an alternating current.

3. The fuel cell system according to claim 2, further comprising an electric motor to which the alternating current is supplied form the inverter.

4. The fuel cell system according to claim 1, wherein the electric component is a DC-DC converter configured to transform a voltage output from the fuel cell.

5. The fuel cell system according to claim 4, further comprising a secondary battery electrically connected to the fuel cell through the DC-DC converter,
wherein the control means controls the amount of current output from the fuel cell by adjusting switching frequency to be applied to the switching elements in the DC-DC converter when the secondary battery is charged with the electrical power generated in the fuel cell.

6. The fuel cell system according to claim 1, further comprising switching means configured to switch permission and inhibition to turn ON simultaneously all of a plurality of the switching elements connected in series.

7. The fuel cell system according to claim 1, further comprising a current sensor configured to detect the amount of current output from the fuel cell, wherein the control means performs the ON/OFF control of the switching elements based on the amount of current detected by the current sensor.

8. The fuel cell system according to claim 1, further comprising a voltage sensor configured to detect the level of voltage of the fuel cell, wherein the control means performs the ON/OFF control of the switching elements based on the level of voltage detected by the voltage sensor.

9. The fuel cell system according to claim 1, further comprising a current sensor configured to detect the amount of current output from the fuel cell, and a voltage sensor configured to detect the level of voltage of the fuel cell,
wherein the control means performs the ON/OFF control of the switching elements based on the amount of current detected by the current sensor and the level of voltage detected by the voltage sensor.

10. The fuel cell system according to claim 1, wherein the fuel cell and the electric component have a common coolant path through which a coolant is circulated in the fuel cell and the electric component.

11. A fuel cell system comprising:
a fuel cell configured to generate electrical power in electrochemical reaction of combining oxidizing agent gas and fuel gas;
an auxiliary equipment for use in the generation of electrical power in the fuel cell; and
control means configured to perform the generation of electrical power by the fuel cell nearly at an operating point having a low voltage in all of operating points of the fuel cell in order to generate the electrical power necessary for operating the auxiliary equipment by controlling at least of one of current and voltage of the fuel cell, and configured to provide the generated electrical power to the auxiliary equipment.

12. A fuel cell system to be mounted on a vehicle, comprising:
a fuel cell configured to generate electrical power in electrochemical reaction of combining oxidizing agent gas and fuel gas;
an auxiliary equipment for use in the generation of electrical power in the fuel cell;
a drive motor for driving the vehicle; and
control means configured to perform the generation of electrical power by the fuel cell nearly at an operating point having a low voltage in all of operating points of the fuel cell in order to generate the electrical power necessary for operating both the auxiliary equipment and the drive motor by controlling at least of one of current and voltage of the fuel cell, and configured to provide the generated electrical power to the auxiliary equipment and the drive motor.

13. The fuel cell system according to claim 11, wherein the auxiliary equipment comprises at least oxidizing agent gas supply means that is configured to supply oxidizing agent gas to the fuel cell.

14. The fuel cell system according to claim 12, wherein the auxiliary equipment comprises at least oxidizing agent gas supply means that is configured to supply oxidizing agent gas to the fuel cell.

15. The fuel cell system according to claim 11, wherein the control means obtains a current-voltage characteristic showing a relationship between current and voltage to be output from the fuel cell and determines an operating point having a low voltage in the operating points for the fuel cell.

16. The fuel cell system according to claim 12, wherein the control means obtains a current-voltage characteristic showing a relationship between current and voltage to be output from the fuel cell and determines an operating point having a low voltage in the operating points for the fuel cell.

17. The fuel cell system according to claim 15, further comprises voltage detection means that is configured to detect the voltage of the fuel cell, wherein
the control means obtains newly the current-voltage characteristic of the fuel cell when the voltage detected by the voltage detection means exceeds the voltage corresponding to the operating point having a low voltage, and determines the optimum operating point having a low voltage in the operating points for the fuel cell based on the newly obtained current-voltage characteristic of the fuel cell.

18. The fuel cell system according to claim 16, further comprises voltage detection means configured to detect a voltage of the fuel cell, wherein
the control means obtains newly the current-voltage characteristic of the fuel cell when the voltage detected by the voltage detection means exceeds the voltage corresponding to the operating point having a low voltage, and determines the optimum operating point having a low voltage in the operating points for the fuel cell based on the newly obtained current-voltage characteristic of the fuel cell.
